(19) United States
(12) Patent Application Publication
(10) Pub. No.: US 2005/0072260 A1
(43) Pub. Date: Apr. 7, 2005

(54) Method for driving multiple-module mechanisms by a single motor and redundant modular robots produced therefrom

(76) Inventors: Anani Ananiev, Orebro (SE); Evgeniy Petrov, West Babylon, NY (US); Banko Hadjiyski, Franklin Square, NY (US); Ivan Kalaikov, Orebro (SE)

Correspondence Address: EVGENIY PETOV, 55 CLAIRE COURT, WEST BABYLON, NY, 11704, US

(21) Appl. No.: 10/678,787

(22) Filed: Oct. 3, 2003

(51) Int. Cl. B25J 17/00

(52) U.S. Cl. 74/490.01

(57) ABSTRACT

A method for driving multiple-module mechanisms by a single motor and redundant modular robots produced therefrom comprises a flexible shaft, which transports the rotation from only one irreversible motor to the mechanisms inside all multiple modules of the robot by means of a plurality of pairs of electromagnetic clutches and respective kits of transmission and driving wheels to distribute selectively the torque/rotation of the motor independently to anyone of the robot modules, electromagnetic breaks keep the desired pose of the robot. A simple control system regulates the speed of the motor and employs simple on-off logic control of the electromagnetic clutches and breaks based on feedback of a set of sensors measuring the angle between each two consecutive robot modules. The versatile kinematics provides the possibility the same construction to be used for implementing a manipulator arm, “elephant trunk”, “snake” or “earthworm”.

### BACKGROUND OF THE INVENTION

1. Field of the Invention

The present invention relates to a method for driving mechanisms assembled from multiple modules of the same type and various constructions of redundant modular robots produced therefrom, which are suited for various tasks in places that are not easily accessible to operators and mobile rescue machine.

2. Description of the Prior Art

In this description, the conventional vocabulary used in the technical field of robotics will be used in general. By “robot” is meant an articulated mechanical system constituted by a connection of at least two modules, with which is associated a control unit.

By the term “end-effector” is meant any system, active or passive, allocated normally at the distal end of the robot construction, adapted to the application envisaged, for example a gripper, a point, a tool, etc.

By the term “position” is meant a position and/or an orientation in space, of the end-effector or of a mark connected to an element considered with respect to a reference mark.

By the term “modular” is meant a repetition of units having the same architecture, these units able to be identical or different by their dimensions. Auxiliary units of a different type may, in some cases, be inserted between the modules.

Industrial robots are constructed by bodies or members connected between them such that to permit a rotation or a translation of one member with respect to other neighboring members. The members differ from each other in order to specialize the robot to a given task. Normally, robots have mechanical complexity and high cost. Moreover, they are not redundant and are therefore incapable of functioning correctly in case of more complicated robot configurations or motions.

The redundant robots have been conceived more recently for intervening in inconvenient or quasi-closed environments. Redundant robot means a robot with surplus numbers of modules with respect to what is required and sufficient to position the robot end-effector in the space. The redundant modules provide additional mobility to the robot for positioning the end-effector in several different manners. Redundancy can improve robot versatility in complex environments, where the extra modules can be used for obstacle avoidance, or to overcome deficiencies arising from kinematical, mechanical, and other design limitations inherent in non-redundant manipulators. Because of their highly articulated structures, hyper-redundant robots are superior for applications and operation in very complicated and unusual environments.

Several prior art techniques that are used for driving multiple-module mechanisms and producing redundant modular robots are known. They are analogous in morphology and operation to “snakes,” “elephant trunks,” “tentacles” or “earthworms”.

The first technique is referred as cable (wire rope) driven robots where the articulated robot modules are individually driven and controlled by cable systems. Diverse modifications of this concept are known, but all they possess various types of deficiencies such as partial or total breakdown of the robot in the case of cable breakage, non-controllable robot in case of failure of a transmission, limited or very limited working space, need of plurality of driving motors associated with respective degrees of freedom, which requires also very complicated control system for all motors.

A second prior art technique referred as multiple rotation robot mechanism is known that avoids the use of cables (wire ropes) but involves a lot of driving motors, which result in higher own robot weight and complex control system.

A third prior art technique referred as deformation in a plane is known that also avoids the limitations involved by using the cables (wire ropes) but also employs relatively high number of driving motors, which give higher robot weight and complex control system.

All pointed prior art techniques have the disadvantage of using large number of motors with respective multi-axes control system, the complexity of which is increased due to the need of synchronous operation of different subsets of motors. Hence, the existing solutions so far accommodate limitations both in terms of complexity and costs.

Therefore, a need exists in the art of driving modular redundant robots for an improved technique for extremely simplified driving of multiple-module mechanisms, which are either identically repetitive or with some dimensional modifications, each module itself being constructed of repetitive elements, and producing modular redundant robots therefrom in order to overcome the limitations of the prior art.

An object is to provide redundant modular robots, the construction of which is expandable and reconfigurable according to the type of task to be accomplished and which is driven by a single irreversible motor that requires a very simple single-axes control system.

Another object is to provide redundant modular robots, which are easy to assemble and disassemble because of their simple structure and the low number of used components.

Still another object is to provide redundant modular robots, which are relatively simple, lightweight and economical to manufacture from standard off-the-shelf components.

In accordance with the present invention, a method for driving multiple-module mechanisms by a single motor and redundant modular robots produced therefrom can be carried out. The method is based on a very simplified approach inspired by the functioning of the bodies of animals, which have only one source of energy—their heart, which provides blood to all muscles of the body. Following this principle, the method assumes only one motor that is driving all moving parts and multiple-module mechanisms in a robot. According to this method, an irreversible motor is the only source of energy transferred to all mechanisms. As the produced mechanical energy cannot be easily stored for future use, it must be utilized directly after being delivered to the said multiple-module mechanisms of the said modular robot.

A flexible shaft transports the motor rotation to the mechanisms inside all multiple modules. In order to distribute selectively the energy to a desired destination a kit of electromagnetic clutches and transmission wheels is used. When an electromagnetic clutch is powered-on the flexible shaft rotation is translated to the shaft of the destination mechanism through a respective transmission wheel. After a desired angle of rotation of the so driven said mechanism is achieved, the electromagnetic clutch is switched-off. An electromagnetic break can be included when it is desired that the said mechanism remain at this said desired angle of rotation.

To allow both positive and negative said desired angle of rotation of the said mechanism, a second complementary electromagnetic clutch is attached appropriately to another complementary said transmission wheel. The operation of the said complementary electromagnetic clutch and said complementary transmission wheel is provided in the same way.

The method for driving multiple-module mechanisms by a single irreversible motor using the above mentioned principle requires a simple control system, the first part of which has the main task to change and stabilize the angular speed of the motor. The second part of the said control system employs simple on-off logic control and can be implemented on variety of commercial programmable controllers or can be embedded in the redundant modular robot produced therefrom.

The present invention is further directed to a redundant modular robot produced from multiple modules driven by a single motor. This apparatus is based on the very simplified said method for driving multiple-module mechanisms using only a single irreversible motor without the need of multiple motors, which drive separate robot modules and mechanisms, or groups of such mechanisms.

In the preferred embodiment, a redundant modular robot, produced from multiple-module mechanisms driven by a single irreversible motor, can achieve the above-mentioned objects. There are various possible constructions of the said multiple link mechanisms and various possible configurations of said redundant robots produced therefrom. These two types of varieties will be further explained as detailed descriptions of several preferred embodiments.

The implementation of said apparatus is first disclosed by the general description of a redundant modular robot comprising the following main structural components:
a) a plurality of connected to each other robot modules driven by the said flexible shaft, each of which has the same internal construction, performs the same type of motion, and articulates around a common inter-link shaft with the next adjacent module forming a chain of multiple modules;
b) a driving motor the body of which is fixed to the proximal module of said chain of multiple modules, the shaft of which is connected to the proximal side of said flexible shaft, the distal side of which is extended up to the desired number of modules in the redundant robot construction;
c) an end-effector connected to the distal module in the said chain of multiple modules for performing desired manipulations of the redundant robot;
d) if a manipulator arm or “elephant trunk” configuration of the redundant robot is desired, the distal module of said chain of modules is fixed on a base installed to appropriate working space, otherwise the redundant robot can perform motions like “snake” or “earthworm”.

The implementation of said apparatus is further disclosed by the general description of one of the all multiple modules comprising a mechanism with nearly the same types and number of interconnected components, namely:
a) a primary driving wheel fixed to the said flexible shaft for transferring the rotation of the driving motor to the mechanism of said module;
b) a pair of primary transferring wheels each of which is coupled to the said primary driving wheel such that the said primary transferring wheels have opposite directions of rotation to each other;
c) a pair of electromagnetic clutches, the body of which is fixed to the body of said module by a fixture, and the shaft of each said electromagnetic clutch is fastened to one of said primary transferring wheels;
d) a pair of secondary transferring wheels each of which is fixed to the moving part of the respective said electromagnetic clutch, such that when the said electromagnetic clutch is powered-on, the said secondary transferring wheel receives the rotation from the primary transferring wheel;
e) a secondary driving wheel, which is fixed to the said inter-link shaft that connects two adjacent said modules of the robot, and is also coupled to both said secondary transferring wheels such that receives the rotation from one of said secondary transferring wheels and rotates through the said inter-link shaft the said next adjacent module in the said chain of modules;
f) an encoder the body or which is fixed to the body of said module such that the angle of rotation of the said inter-link shaft is measured by the said encoder;
g) an electromagnetic break the body of which is fixed to the body of said module such that when the said break is powered on the angle of rotation between the said module and its said adjacent module is kept fixed for providing a desired configuration of the robot.

One advantage of the present invention is that it provides a method for driving multiple-module mechanisms by a single irreversible motor and redundant modular robots produced therefrom, whereby the limitations as encountered by the prior art can be overcome. This method can be used in a variety of mechanical constructions where modularity and simplicity are aimed.

Other advantage of the present invention is that it provides a method for driving mechanisms assembled from multiple modules of the same type and redundant modular robots produced therefrom such that the modules of which are either identically repetitive or with some dimensional modifications, each module itself being constructed of repetitive elements.

Another advantage is that it provides redundant modular robots, the construction of which can be expanded and reconfigured according to the type of task to be accomplished.

Still another advantage is that it provides redundant modular robots, which use low variety of components that are easy to assemble and disassemble that makes the robots relatively simple and economical to manufacture and maintain.

Further advantage is that it provides redundant modular robots with relatively lightweight structure that has potentially higher payload capacity.

Still further advantage is that it provides redundant modular robots with simplified control system for independent control of all robot modules employing dominantly on-off logic control actions to the electromagnetic clutches and breaks and simple single-axis motor regulator.

These and other objects and advantages of the present invention will be apparent from the detailed description below taken together with the drawings.

### BRIEF DESCRIPTION OF THE DRAWINGS

FIG. 1 presents the kinematics structure of the first preferred embodiment of a redundant modular robot, which performs motions like a “snake”, in which the mechanisms in the modules are based on worm gearing.

FIG. 2 presents the kinematics structure of the second preferred embodiment of a redundant modular robot, which performs motions also like a “snake”, but in which the mechanisms in the modules are based on bevel gearing.

FIG. 3 presents the kinematics structure of the third preferred embodiment of a redundant modular robot, which performs motions like a single-arm robot manipulator, in which the mechanisms in the modules are based on worm gearing.

### DETAILED DESCRIPTION OF THE PREFERRED EMBODIMENTS

The present invention provides a method for driving multiple-module mechanisms by a single irreversible motor and redundant modular robots produced therefrom. They are created on the base of the essential concept presented below.

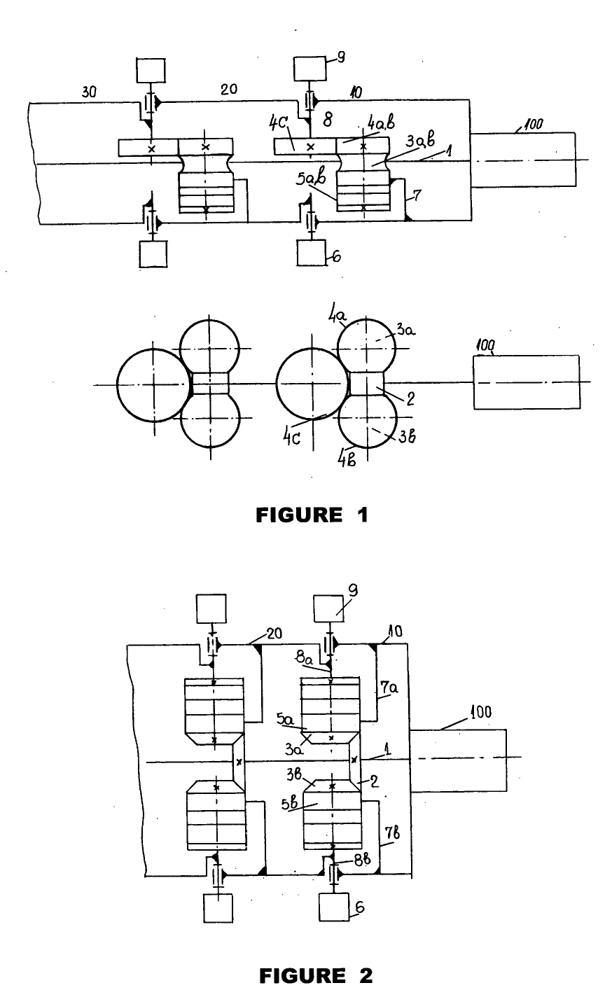

A first embodiment of the redundant modular robot of the invention, as seen on FIG. 1, has a plurality of connected to each other robot modules 10, 20, 30, etc. driven by a flexible shaft 1. Each of the modules 10, 20, 30, etc., has the same internal construction and performs the same type of motion. A pair of two adjacent modules, for example 10 and 20, or 20 and 30, articulates around a common inter-link shaft 8 such that all modules 10, 20, 30, etc., form a chain of multiple modules.

The driving motor 100 is fastened to the body of the proximal module 10 of said chain of multiple modules. The output shaft of the motor 100 is connected to the proximal side of said flexible shaft 1. The flexible shaft 1 is extended up to a length corresponding to the desired number of modules 10, 20, 30, etc., in the redundant robot construction and transfers the torque produced by the motor to all said modules 10, 20, 30, etc., as well as possibly the end-effector, articulated to the distal module of the said chain of modules (not shown on FIG. 1). This end-effector performs the desired manipulations of the redundant robot; therefore its construction is application dependent and is out of the scope of the present invention.

Refering to FIG. 1, the proximal module 10 is not fastened to any device; therefore appropriate “free” motion of the proximal end of the redundant modular robot can be achieved by respective programming of the robot control unit (not shown as irrelevant to the present invention). This type of motion is characteristic to some animals' motions; hence the structure on FIG. 1 corresponds to a “snake” robot.

The implementation of each module 10, 20, 30, etc., is further disclosed by the description of the internal mechanism of these modules, comprising the same types and number of interconnected components. Referring again to FIG. 1, a primary driving wheel 2 is fixed to the said flexible shaft 1 and transfers the rotation from the driving motor 100 to the mechanism of said module. A pair of primary transferring wheels 3a and 3b coupled to both sides of the primary driving wheel 2 such that primary transferring wheel 3b rotates at opposite direction to the 3a wheel. These primary driving wheels 3a and 3b rotate permanently as the driving motor 100 and the flexible shaft 1 do.

Pair of electromagnetic clutches 5a and 5b is provided for switching one of the opposite directions of rotations further to the mechanism. The body of the clutches 5a and 5b are fastened to the body of said module through a fixture 7. The shaft of clutch 5a is fixed to the primary transferring wheel 3a and the shaft of clutch 5b is fixed to the primary transferring wheel 3b. When one of the clutches 5a and 5b is activated by powering-on the respective direction of rotation if propagated further to the mechanism. If none of the clutches 5a and 5b is activated no rotation is transferred to the mechanism and the respective module does not change its pose.

Pair of secondary transferring wheels 4a and 4b is provided for receiving the rotation from the primary transferring wheels 3a and 3b respectively. Each of these wheels 4a and 4b is fixed to the moving part of the respective electromagnetic clutch 5a or 5b. When clutch 5a is activated, the secondary transferring wheel 4a receives the rotation from primary transferring wheel 3a. When clutch 5b is activated, the secondary transferring wheel 4b receives the rotation from primary transferring wheel 3b.

Secondary driving wheel 4c is coupled to both secondary transferring wheels 4a and 4b such that receives the rotation from one of 4a or 4b. This secondary driving wheel 4c is fixed to the said inter-link shaft 8 that connects the pair of two adjacent modules of the robot, for example 10 and 20, or 20 and 30. As the shaft 8 is fastened to the body of the next module 20 and articulates at the body's edge of module 10, when the secondary driving wheel rotates, the torque is transferred to swivel the module 20 at a desired relative angle to module 10. The same happens for each successive pair like modules 20 and 30, etc. The encoder 9, the body or which is fixed to the body of module 10 (or 20, 30, etc.) and the shaft of which is attached to shaft 8 measures this relative angle. An electromagnetic break 6 is provided to keep this angle fixed for performing a desired pose of the robot. The body of the break 6 is fixed to the body of module 10 (or 20, 30, etc.) and the shaft is fastened to the inter-link shaft 8.

In order to achieve higher torques for the plurality of modules 10, 20, 30, etc., and their mechanisms, the triple of wheels 3a, 2 and 3b form a worm-type gear. At the same time the triple of wheels 4a, 4b and 4c can constitute for example normal teeth-wheel gear with appropriate ratio.

As the kinematical scheme and principle of operation of the first embodiment mechanism can be designed in a variety of concrete mechanical constructions, they are considered as not deviating from the spirit of the present invention and therefore embraced by it.

A second embodiment of the redundant modular robot of the invention is illustrated on FIG. 2. For convenience of the explanation and easy comparisons of the schemes all participating components have the same indices. The main difference between the first and second preferred embodiment is in the way of implementing the internal mechanism of the multiple modules. Therefore the general structure of the redundant modular robot is the same as in the first embodiment. It is presented here for keeping the completeness of the description.

The redundant modular robot has a plurality of connected to each other modules 10, 20, 30, etc. driven by a flexible shaft 1. Each of the modules 10, 20, 30, etc., has the same internal construction and performs the same type of motion. A pair of two adjacent modules, for example 10 and 20, or 20 and 30, articulates around a common inter-link shaft 8 divided in two parts 8a and 8b, such that all modules 10, 20, 30, etc., form a chain of multiple modules.

The driving motor 100 is fastened to the body of the proximal module 10 of said chain of multiple modules. The output shaft of the motor 100 is connected to the proximal side of said flexible shaft 1. The flexible shaft 1 is extended up to a length corresponding to the desired number of modules 10, 20, 30, etc., in the redundant robot construction and transfers the torque produced by the motor to all said modules 10, 20, 30, etc., as well as possibly the end-effector, articulated to the distal module of the said chain of modules (not shown on FIG. 2). Referring to FIG. 2, as the proximal module 10 is not fastened to any device, the structure on FIG. 2 corresponds also to a “snake” robot.

The particular implementation of each module 10, 20, 30, etc., in this second embodiment is further disclosed by the description of the internal mechanism of these modules. Referring again to FIG. 2, a driving wheel 2 is fixed to the said flexible shaft 1 and transfers the rotation from the driving motor 100 to the mechanism of said module. A pair of transferring wheels 3a and 3b coupled to both sides of the driving wheel 2 such that transferring wheel 3b rotates at opposite direction to the 3a wheel. These driving wheels 3a and 3b rotate permanently as the driving motor 100 and the flexible shaft 1 do.

Pair of electromagnetic clutches 5a and 5b is provided for switching one of the opposite directions of rotations further to the mechanism. The body of the clutches 5a and 5b are fastened to the body of said module through fixtures 7a and 7b. The shaft of clutch 5a is fixed to the transferring wheel 3a and the shaft of clutch 5b is fixed to the transferring wheel 3b. When one of the clutches 5a and 5b is activated by powering-on the respective direction of rotation if propagated further to the mechanism. If none of the clutches 5a and 5b is activated no rotation is transferred to the mechanism and the respective module does not change its pose.

The moving part of the respective electromagnetic clutch 5a or 5b receives the rotation from the primary transferring wheels 3a and 3b. When clutch 5a is activated, its moving part receives the rotation in one direction from transferring wheel 3a and transfers it to shaft 8a. When clutch 5b is activated, its moving part receives the rotation in the opposite direction from transferring wheel 3b and transfers it to shaft 8b.

As the shaft parts 8a and 8b are fastened to the body of the next module 20 and articulates at the body's edge of module 10, when one of the clutches 5a or 5b is activated, the torque is transferred to swivel the module 20 at a desired relative angle to module 10. The same happens for each successive pair like modules 20 and 30, etc. The encoder 9, the body or which is fixed to the body of module 10 (or 20, 30, etc.) and the shaft of which is attached to shaft 8a measures this relative angle. An electromagnetic break 6 is provided to keep this angle fixed for performing a desired pose of the robot. The body of the break 6 is fixed to the body of module 10 (or 20, 30, etc.) and the shaft of 6 is fastened to the shaft 8b.

In order to achieve appropriate torques for the plurality of modules 10, 20, 30, etc., and their mechanisms, the triple of wheels 3a, 3b and 3c should be selected to give appropriate ratio of the bevel gear.

As the kinematical scheme and principle of operation of the second embodiment mechanism can be designed in a variety of concrete mechanical constructions, they are considered as not deviating from the spirit of the present invention and therefore embraced by it.

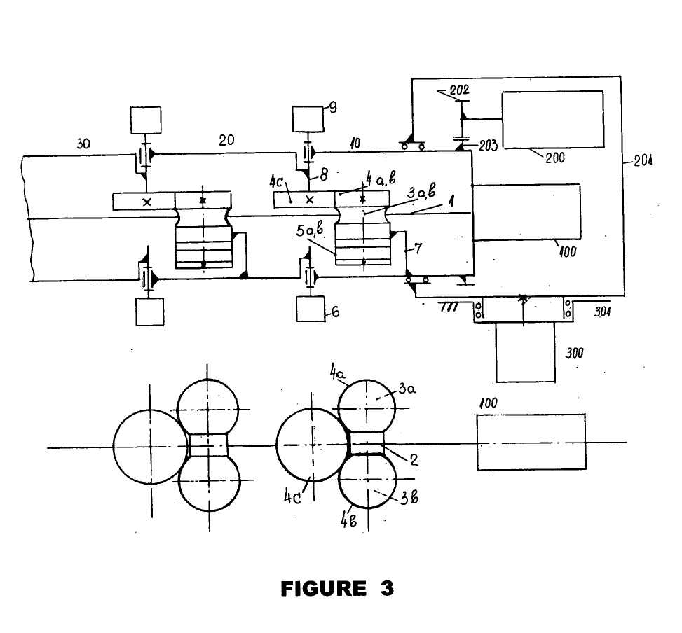

A third embodiment obtained by modification of the first embodiment is shown on FIG. 3, where manipulator arm or “elephant trunk” configuration of the redundant modular robot is presented. In this case the entire scheme of the first embodiment is preserved and augmented by a base module providing two additional robot degrees of freedom, installed to appropriate working space.

One axial rotating degree of freedom is obtained by a second driving motor 200, the body of which is fastened to a body 201 articulating around the body of the proximal robot module 10. Pair of transferring wheels 202 and 203 is used for passing the torque of motor 200 to the body of module 10. Wheel 202 is fixed to the output shaft of the motor 200 and wheel 203 is fixed around the body of module 10. The speed and desired angle of rotation are achieved by appropriate control of motor 200.

Second rotating degree of freedom about a vertical axis is obtained by a third driving motor 300, the body of which is fastened to the body of the base 301 installed to the working space. The body 201 articulates in appropriate bearing in the body 301. The output shaft of motor 300 is fixed to body 201, which receives the torque produced by motor 300 directly. The speed and desired angle of rotation are achieved by appropriate control of motor 300.

Alternatively, the base 301 can be installed on a mobile platform for performing mobile robot manipulation.

As this invention may be concretized in several forms without deviating from the spirit of indispensable characteristics thereof, the present embodiments are therefore illustrative and not restrictive, since the scope of the invention is defined by the appended claims rather than by the description preceding them, and all changes that fall within the metes and bounds of the claims, or equivalence of such metes and bounds thereof are therefore intended to be enfolded by the claims.

1. A method for driving multiple-module mechanisms by a single motor and redundant modular robots produced therefrom based on a very simplified approach employing only one irreversible motor that is driving the said mechanisms inside the multiple modules in said redundant modular robot by means of flexible shaft, which transports the torque/rotation of said single irreversible motor to the said mechanisms inside all multiple modules of the robot,
said method further using:
a plurality of pairs of electromagnetic clutches and respective kits of transmission and driving wheels to distribute selectively the torque/rotation of the said single irreversible motor to anyone of the said robot modules as a desired destination, such that when a said electromagnetic clutch is powered-on the rotation in one direction of said flexible shaft is translated to the shaft of the destination said mechanism through a respective said transmission wheel or alternative said clutch and respective said transmission wheel are activated if the opposite direction of rotation is desired,
an electromagnetic break for keeping the desired relative angle between two adjacent said modules of said redundant modular robot,
a simple control system, the first part of which has the main task to regulate and stabilize the angular speed of said single irreversible motor, while the second part of the said control system employs simple on-off logic control of said electromagnetic clutches and said breaks based on feedback of a set of angular sensors measuring the angle between each two consecutive said robot modules.

2. A redundant modular robot comprising a plurality of modules each of which being with the same internal construction and being articulated at one end thereof to the next adjacent said module by an inter-link shaft such that the entire said robot forms a chain of multiple said modules that are driven by a flexible shaft, which penetrates all said modules, the distal side of which being extended up to the desired number of said modules in said robot, the proximal end of said flexible shaft being connected to the output shaft of a driving irreversible motor, the body of which being fixed to the proximal module of said chain of multiple modules, and an end-effector connected to the distal module of said robot.

3. A redundant modular robot as in claim 2, characterized in that same construction can have double functioning, meaning when said proximal module of said chain of multiple modules is fixed on a base installed to appropriate working space the said robot behaves as a manipulator arm or “elephant trunk”, and when said proximal module of said chain of multiple modules is unfixed the said robot behaves as a “snake” or “earthworm”.

4. A redundant modular robot as in claim 2, characterized in that each of said multiple modules comprises a primary driving wheel being fixed to said flexible shaft, a pair of primary transferring wheels each of which is coupled to said primary driving wheel such that the said primary transferring wheels have opposite directions of rotation to each other, a pair of electromagnetic clutches, the body of which is fixed to the body of said module and the shaft of each said electromagnetic clutch is fastened to one of said primary transferring wheels, a pair of secondary transferring wheels each of which is fixed to the moving part of the respective said electromagnetic clutch, such that when said electromagnetic clutch is powered-on, the said secondary transferring wheel receives the rotation from said primary transferring wheel, a secondary driving wheel, which is fixed to the said inter-link shaft and is also coupled to both said secondary transferring wheels such that receives the rotation from one of said secondary transferring wheels and rotates through said inter-link shaft the said next adjacent module, an encoder the body of which is fixed to the body of said module such that the angle of rotation of the said inter-link shaft is measured by said encoder, an electromagnetic break the body of which is fixed to the body of said module such that when the said break is powered on the angle of rotation between the said module and its said next adjacent module is kept unchanged for providing a desired pose of said robot.

5. A redundant modular robot as in claim 3, characterized in that when a manipulator arm or “elephant trunk” is constructed one axial rotating degree of freedom is introduced by a second motor, the body of which is fastened to a cylindrical body articulating around the body of the said proximal module such that a pair of transferring wheels the first of which being fixed to the output shaft of the said second motor and the second of said transferring wheels is fixed around the body of said proximal module.

6. A redundant modular robot as in claim 5, characterized in that a second degree of freedom swiveling around an axis that is perpendicular to the axis of said axial rotating degree of freedom by means of a third motor, the body of which is fastened to a base and the output shaft of said third motor is fixed to said cylindrical body, which articulates in appropriate bearing in the said base that is can be installed at appropriate working space or on a mobile platform for performing mobile robot manipulations.
